(19) United States
(12) Patent Application Publication
(10) Pub. No.: US 2011/0096963 A1
(43) Pub. Date: Apr. 28, 2011

(54) METHOD AND SYSTEM FOR CUSTOMIZING MEDICAL IMAGES BASED ON PATIENT PREFERENCE

(76) Inventors: Raja Shekhara, Karnataka (IN); Chetan Hassan Devendrakumar, Karnataka (IN); Arun Kumar Chandrashekarappa, Karnataka (IN)

(21) Appl. No.: 12/868,780

(22) Filed: Aug. 26, 2010

(30) Foreign Application Priority Data
Oct. 22, 2009 (IN) 2555/CHE/2009

(51) Int. Cl. G06K 9/00; G10L 17/00

(52) U.S. Cl. 382/128; 704/246

(57) ABSTRACT

A method and system for customizing medical images based on patient preference is disclosed herein. The method comprises: receiving patient preference on displaying patient identification information in a medical image; and providing customized patient identification information on the image based on the patient preference. The image with customized patient information is stored in a media.

### FIELD OF INVENTION

This invention relates generally to method of reducing patient identification errors in medical images through customization of medical images and more particularly to, a method and system for providing patient identification information in medical images in patient's preferred language.

### BACKGROUND OF INVENTION

Conventionally, English is used as a common language in annotating medical images and reports. Once the medical report and image film are given to a patient, the patient needs to keep it safe and re produce the same during further examination stages.

However in rural area the literacy, especially the English literacy is low and the people may be well versed with their local language only. In some countries, there are different languages and people may not be comfortable with English language or any other common language.

Since almost all hospitals use English as the mode of communication, this flows down to even the reports or films that is generated and handed over to the patient. As medical reports and films are in English language, the patient ends up in confusion when they have to store or bring it back for repeated visits to the hospital and this could result in misplacing the reports.

In a family, all the family members might need to store their diagnostic reports or diagnostic images. Generally, the patient parameters are annotated in the medical image in English language. Unfortunately, the people who are not able to read English, may not be able to identify his or her own films or reports. This results in misplacing or destroying the medical reports in error, as the patient might get confused with other family member's report. This leads to repeat travel to the hospitals or extra scans in situations that demand urgent attention, rising both the cost/time to treat the patient.

In the event of clinician not verifying the authenticity of the images, he may consider the image brought by the patient as genuine and this may result in wrong treatment plans.

Thus there exist a need for an improved method and system for customizing medical images using patient's preferred or local language.

### SUMMARY OF INVENTION

The above-mentioned shortcomings, disadvantages and problems are addressed herein which will be understood by reading and understanding the following specification.

One embodiment of the present invention provides a method of customizing medical images based on patient preference. The method comprises: receiving patient preference on displaying patient identification information in a medical image; providing customized patient identification information on the image based on the patient preference; and storing the image with customized patient information in a media.

In another embodiment; a method of reducing patient identification error in medical images is disclosed. The method comprises: processing image data of a patient having at least image information and patient identification information, to generate medical images; obtaining patient preferred language for displaying patient identification information in the medical image; selecting a patient identification parameter from the patient identification information; incorporating at least one patient identification parameter in patient preferred language in the medical image; printing the medical image into films and medical reports.

In another embodiment, an image processing system for customizing the medical images is disclosed. The system comprises: a processing unit configured to receive the image data and patient identification information; a user input device configured to receive the patient preference on patient identification information display; a user interface configured to provide selectable option of incorporating patient preference on displaying the patient identification information on the image data; and a display device configured to display image with patient identification information represented in patient preferred language.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram of an image processing system as described in an embodiment of the invention;

FIG. 2 is a block diagram of an imaging system incorporating the image Processing system as described in an embodiment of the invention;

FIG. 3 is a flowchart illustrating medical image customization method as described in an embodiment of the invention;

FIG. 4 is a flowchart illustrating a method of reducing identification errors in a medical image as described in an embodiment of the invention; and

FIGS. 5A-5C illustrate schematic representation of customized medical images as described in an embodiment of the invention.

### DETAILED DESCRIPTION OF INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

Embodiments of the present invention provide a method and system for customizing medical images. The method further discloses displaying patient identification parameter such as patient's name in a language preferred by the patient. This will help easy identification of the medical film or report corresponding to a patient even if the patient doesn't have the knowledge of English language. In an embodiment, a graphical interface is provided on an image viewer or on a reporting tool, such that patient information could be incorporated into the image in patient's preferred language.

The term “patient identification information” referred in the specification need not refer to one parameter, but includes a list of parameters unless otherwise specified and need not be limited to the examples mentioned in the specification. Rather, the patient identification information may be any unique information related to patient. The invention could be extended to illiterate people by customizing the medical image with some symbols that could be unique to the patient such as thumb impression and the patient can relate his medical image or report to that symbol.

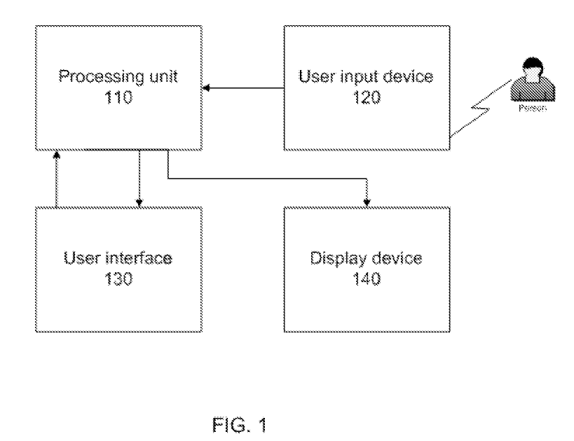

FIG. 1 is a block diagram of image processing system configured to customize medical images as described in an embodiment of the invention. The image processing system comprises: a processing unit 110, a user input device 120, a user interface 130 and a display device 140. The processing unit 110 is configured to receive image data from an imaging system or from an image storage device. The image data could include image information as well as the patient information. The image data need to be processed to generate the medical image and that could be stored in any media. The processing unit 110 is further provided with patient identification information. Patient identification information could include different patient identification parameter such his name, age, gender etc. In an example, the patient identification information could include patient demographic information. The patient identification information could be collected from the patient while processing the image data or could be collected from the patient at the time of registration or from his previous history records. Alternately, the patient identification information could be provided as a part of the image data.

The user input device 220 is configured to provide the patient preference on display of the medial image. In an embodiment, the patient's preference on customizing the medical image is obtained through the user input device. The user input collects the patient information, especially the language in which the patient information needs to be displayed on the medical image. Various user preferences may be collected, such as language, color, style or any other unique parameter that will help the patient to relate the medical image to the patient or to help the patient in identifying the image belonging to him. User input device 120 may collect the patient preference at the time of registration or while processing the image data. The user input device 120 may also assist the patient in selecting the patient identification parameter that need to be translated into patient's preferred language and to be incorporated into the medical image.

The user interface 130 is provided in association with the processing unit 110. The user interface 130 will assist the radiologist/technologist in selecting the preferred language. The patient may communicate the patient preferred language to the image processing system through the user input device 120. A radiologist/technologist may manually select the patient preferred language using the user interface 130. The selected language could be communicated to the processing unit 110. In an embodiment, a drop down menu having a list of languages may appear next to the patient's name. The user interface 130 may be used to select the patient preferred language by selecting one of the languages from the drop down menu. The user interface 130 could include graphical user interface and or other interfaces such as mouse, joystick, light pen, a touch screen and stylus, a keyboard with cursor keys, or combinations thereof.

In an embodiment, graphic tablet can be used as a medium to input the patient information. It can be stored as it is in the patient's handwriting and could be rendered on the medical image. The information which is in the patient's handwriting can be stored in a private tag.

In another embodiment, the user interface 130 may be a graphical user interface with a drop down menu, configured to assist the radiologist/technologist in manually selecting the patient identification parameter that need to be customized and displayed on the medical image. With reference to the input received from the user input device 120, the user interface 130 assists the radiologist/technologist in selecting the desired patient identification parameter and his preferred language.

In an embodiment, the patient identification parameter and his preferred language could be communicated automatically to the processing unit 110 and the processing unit 110 could translate the desired patient parameter into patient's preferred language and incorporate the same into the medical image.

The processing unit 110 has a translation module 115 and the translation module 115 translate the patient identification parameter or the identification information that need to be displayed in patient's preferred language. The processing unit 110 is configured to receive the patient identification information or the patient identification parameter and preferred language.

The processing unit 110 assists in displaying the medical image with the customized patient information on a display device 140. The display device 140 and the user interface 120 operate together to facilitate the radiologist/technologist to select patient's identification parameter or patient's preferred language. The display device 140 could be any monitor including a CRT display.

Dedicated hardware may be used instead of software and/or firmware for performing image processing, or a combination of dedicated hardware and software, or software in combination with a general purpose processor, or a digital signal processor may be used as the processing unit 110. Once the requirements for such software and/or hardware and/or dedicated hardware are gained from an understanding of the descriptions of embodiments of the invention contained herein, the choice of any particular implementation may be left to a hardware engineer and/or software engineer. However, any dedicated and/or special purpose hardware or special purpose processor is considered subsumed in the block labeled processor 110.

Whether a stand-alone workstation or an image processing system is used, software and/or firmware (hereinafter referred to generically as “software”) can be used to instruct the computer to perform the inventive combination of actions described herein. Portions of the software may have specific functions, and these portions are herein referred to as “modules” or “software modules.” However, in some embodiments, these modules may comprise one or more electronic hardware components or special-purpose hardware components that may be configured to perform the same purpose as the software module or to aid in the performance of the software module. Thus, a “module” may also refer to hardware or a combination of hardware and software performing a function.

The image processing system is further associated with a storage unit 150. The storage unit 150 could be a printer wherein the medical report or image film could be printed. The storage unit 150 could store the image or report in memory (ROM), random access memory (RAM), a miniature hard drive, a flash memory card, or any kind of device (or devices) configured to store instructions to a machine-readable medium or media.

In an embodiment, the patient preference could be obtained through voice recognition technique. The patient could orally communicate his preference and from that his preferred language could be interpreted/obtained.

In an embodiment, the patient identification information or the identification parameter may be displayed in patient's preferred language and in a common language, so that the clinician or reviewer does not have any problem in identifying the image correctly.

The medical image could include multimodality image such as X-ray system, Computer Tomography (CT) Imaging System, Magnetic Resonance Imaging System, Ultrasound Imaging System. It could include DICOM as well as non-DICOM images. Further the customization could be done to medical images including medical film and/or to medical reports.

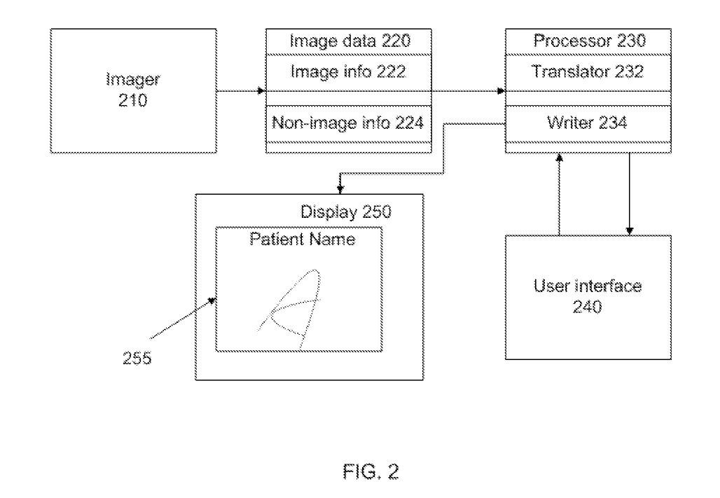

FIG. 2 is a block diagram of an imaging system incorporating the image processing system as described in an embodiment of the invention. The medical images are acquired by a medical imaging system, which essentially includes an imager 210. The medical imaging system can be an X-ray system, Computer Tomography (CT) Imaging System, Magnetic Resonance Imaging System, Ultrasound Imaging System, Positron Emission Tomography (PET) Imaging System, Nuclear Medicine Imaging System etc, but need not be limited to these. Generally, medical images are stored as DICOM images. An image data 220 corresponding to a DICOM image could comprise image information 222 and non-image information 224. The image information 222, includes pixel information of the DICOM image data 220, and the non-image information 224 includes information about imaging parameters, patient information, image attributes, imaging techniques, patient identification information etc. In an embodiment, the non-mage information 224 could be part of the DICOM image header.

In an embodiment, the image data 220 could be in the form of non-DICOM image data such as JPEG, PNG, MOV, MPEG etc. The image data 220 may have a header with patient information or the patient information could be provided along with the image data.

The image data 220 including the image information 222 and the patient identification information is fed to a processor 230. The processor 230 processes the image data 220 and generates medical images. The processor 230 is configured to include a translator 232 and a writer 234.

The user interface 240 is provided in association with the processing unit 110. The user interface 240 will assist the radiologist/technologist in selecting the preferred language. A radiologist/technologist may manually select the patient preferred language using the user interface 240. The selected language could be communicated to the processing unit 110.

Patient preferred language is communicated to the processor 230 and based on the patient input, desired language is selected using the user interface 240. In an embodiment, the user interface 240 could be a graphic interface wherein the image could be displayed and a list of options could be available for the radiologist/technologist/user/patient to select the patient's preferred language. The user interface 240 works in association with the processor 230. The translator 232 translates the patient identification information to the language selected by the radiologist/technologist through the user interface 240. The writer 234 incorporates the patient identification information in the translated language into the medical image. The patient identification information is incorporated into the image 220 such that it is visually detectable. Different techniques could be used to achieve this, and one example is layering technique. Once the patient identification information or parameter is incorporated in a visually detectable format, customized image 255, i.e the medical image with localized patient identification information is generated. The customized image 255 can be displayed on a display 250 before storing into different media.

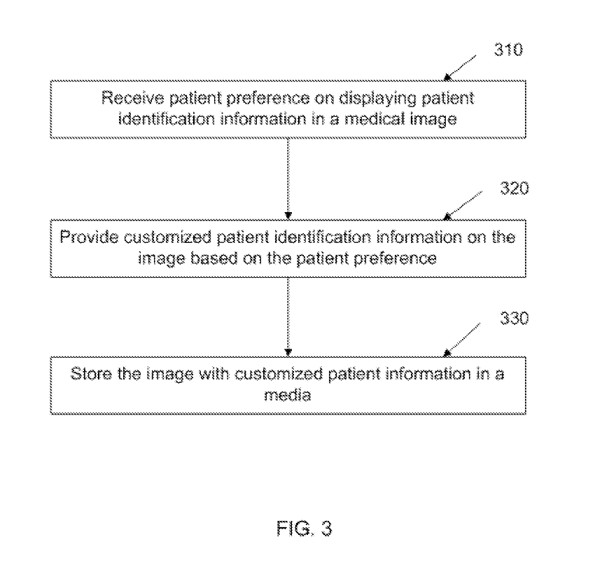

FIG. 3 is a flowchart illustrating medical image customization method as described in an embodiment of the invention. At step 301, patient preference on displaying patient identification information is received. The patient preference could include his preference in displaying his identification information in medical images. The preference is given such that the patient will be able to identify the image corresponding to him at a later stage. At step 320, based on the patient's preference, customized patient information is incorporated into the image. The customized patient information includes patient's unique identification parameter and the unique identification parameter is incorporated into the medical image to relate the image to the patient. The patient's preference is considered to make sure that patient himself will be able to identify the medical image or report corresponding to him. At step 330, the image with customized patient information incorporated, is stored into a media. The patient identification information is incorporated into the image or report and image or report is printed or saved in a machine-readable medium.

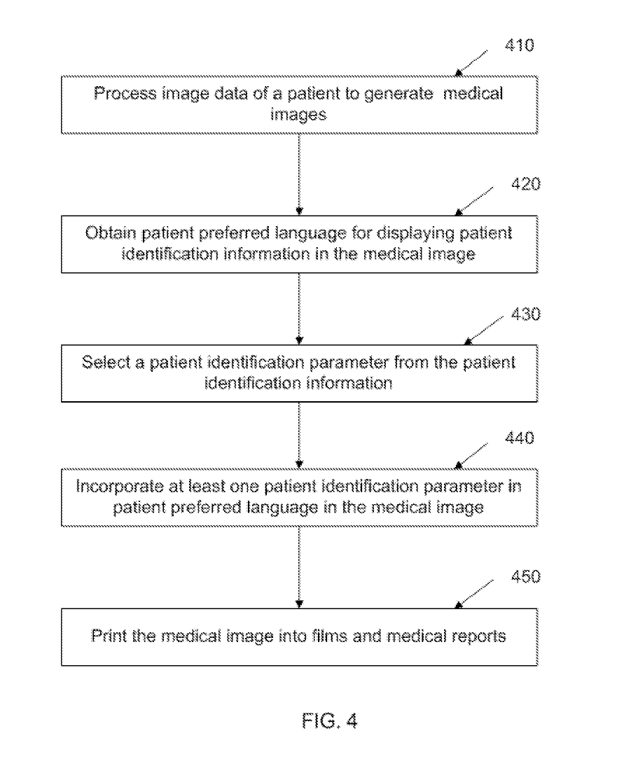

FIG. 4 is a flowchart illustrating a method of reducing identification errors in a medical image as described in an embodiment of the invention. At step 410, an image-data having image information and non-image information is processed to generate medical images. The image information might include pixel information and the non-image information includes patient identification information. The image data could be in DICOM or non-DICOM format. At step 420, patient's preferred language for displaying patient identification information in medical image is obtained. At step 430, patient could select the patient identification parameters of his preference from the patient identification information. At least one of the selected parameter will be displayed on the image in his preferred language. At step 440, the selected patient identification parameter is incorporated into the image in his preferred language. The patient identification parameter such as patient's name is embedded into the image in his local language. At step 450, the image with patient identification information is printed on a film or on medical report. The image could be stored in any machine-readable medium.

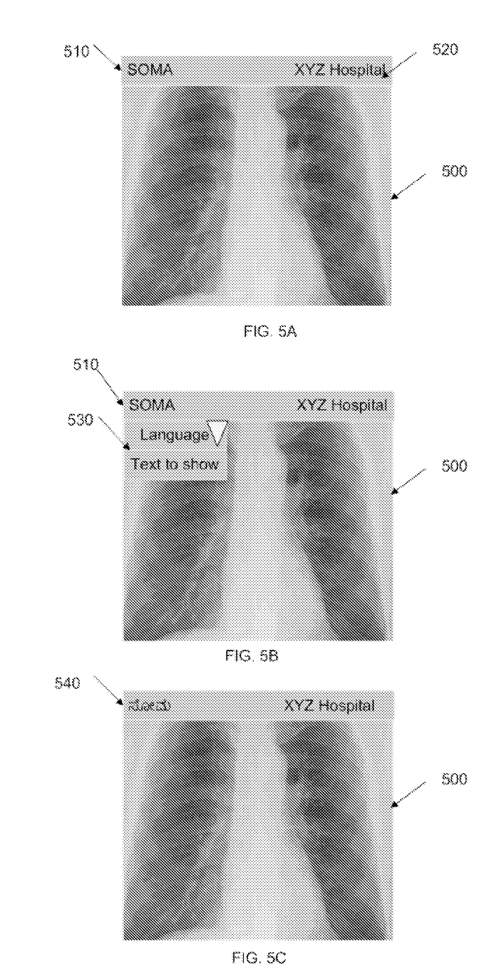

FIG. 5A-5C illustrate schematic representation of customized medical images as described in an embodiment of the invention. A medical image 500 of the patient is obtained. The image 500 has patient information such as patient's name “SOMA” 510 and hospital information 520. Apart from this, image 500 could have different annotations such as comments from clinician, additional patient information etc. Before printing the image 500 or storing into any machine-readable media, the patient name 520 could be translated into a patient's local language or his preferred language. This could be done at image processing or report generation stage. For example, a drop down menu 530 as shown in FIG. 5B could appear on a user interface and a radiologist or technologist could select the patient's preferred or local language from the menu. The patient's name will get translated into the selected language. The translated name or patient's name in his preferred language could be displayed as patient name. The patient name in common language is replaced by patient's name written in local language 540, as shown in FIG. 5C. In an embodiment, the patient name could be displayed in English as well as in patient's local language. In another embodiment, instead of patient's name, his age or date of report could be displayed in patient's local language.

In yet other embodiments of the present invention, a machine readable medium or media may include, but not limited to, magnetic disks and diskettes, optical disks and diskettes, and/or ROM, flash ROM, and/or battery backed RAM, or any other suitable magnetic, optical, or electronic medium or media. The medium (or media) has recorded thereon instructions configured to instruct a system that includes a computer, memory, and a display. The instructions include instructions for receiving patient preference on displaying patient identification information in a medical image and providing customized patient identification information on the image based on the patient preference. The image may be stored in any media. However software and/or firmware (hereinafter referred to generically as “software”) can be used to instruct the computer to perform the inventive combination of actions described herein. Further, in some embodiments, this may comprise one or more electronic hardware components or special-purpose hardware components that may be configured to perform the same purpose as a software module or to aid in the performance of the software module.

The invention is helpful for the patients in countries where English is not the local language and also for people in rural areas who doesn't know English language. The invention provides the flexibility of changing patient name in patient's preferred language while preparing the image or report. These reports or films with patient's name or identification parameter are handed over to patient and this will help them identifying the image. In an example, patient's name along with the imaging or report date could be displayed on the image in patient's local language.

The above-description of the embodiments of the methods and systems has the technical effect of incorporating customized patient identification information in a medical image or report in a language preferred by the patient. An interface is provided to incorporate patient identification information in local language while preparing the report and/or image.

As used herein, an element or step recited in the singular and proceeded with the word “a” or “an” should be understood as not excluding plural elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. Moreover, the terms “computer” and “processor” are used interchangeably herein to refer to either specialized hardware to perform digital signal processing, control, data manipulation, and/or calculations, or a general purpose computer that can be programmed to perform the same functions and/or adapted to interface with external digital signals. The phrases “computer or processor” and “processor or computer” are therefore intended to have equal scope with either of the individual terms and are not intended to imply a dichotomy between the two terms.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. Method of customizing medical images based on patient preference comprising:
receiving patient preference on displaying patient identification information in a medical image;
providing customized patient identification information on the image based on the patient preference; and
storing the image with customized patient information in a media.

2. The method as claimed in claim 1, wherein the patient identification information includes patient demographics.

3. The method as claimed in claim 1, wherein the step of receiving patient preference comprises: obtaining patient preferred language and a patient identification parameter to display patient identification information in the image.

4. The method as claimed in claim 3, wherein the step of receiving patient preference comprises: identifying the patient preferred language using voice recognition technique.

5. The method as claimed in claim 1, wherein the step of providing customized patient identification comprises: providing a user interface facilitating selection of patient preferred language.

6. The method as claimed in claim 3, wherein the method further comprises: translating patient identification parameter in the patient preferred language.

7. The method as claimed in claim 1, wherein the step of storing the image comprises: incorporating the image with the patient identification parameter, the parameter being represented in patient's preferred language, in a machine readable media.

8. The method as claimed in claim 1, wherein the step of storing the image comprises: printing the image with the patient identification parameter, the parameter being represented in patient's preferred language; in medical films and reports.

9. A method of reducing patient identification error in medical images comprises:
processing image data of a patient having at least image information and patient identification information, to generate medical images;
obtaining patient preferred language for displaying patient identification information in the medical image;
selecting a patient identification parameter from the patient identification information;
incorporating at least one patient identification parameter in patient preferred language in the medical image;
printing the medical image into films and medical reports.

10. The method as claimed in claim 9, wherein the patient identification parameters includes patient name.

11. The method as claimed in claim 9, wherein the method further comprises:
incorporating patient identification parameter in a common language.

12. The method as claimed in claim 9, wherein the method further comprises: storing the image with the patient identification parameter in a machine readable media.

13. An image processing system for customizing the medical images comprises:
a processing unit configured to receive the image data and patient identification information;
a user input device configured to receive the patient preference on patient identification information display;
a user interface configured to provide selectable option of incorporating patient preference on displaying the patient identification information on the image data; and
a display device configured to display image with patient identification information represented in patient preferred language.

14. The system as claimed in claim 13, wherein the processing unit includes: a translating module configured to translate patient identification information from a common language to a patient preferred language.

15. The system as claimed in claim 13, wherein the system further comprises: storing unit for storing the image with patient identification information represented in patient's preferred language.

16. The system as claimed in claim 13, wherein the processor is configured to incorporate patient identification information to a medical film.

17. The system as claimed in claim 14, wherein the processor is configured to incorporate patient identification information to a medical report.

18. The system as claimed in claim 13, wherein the medical image includes multi modality images from X-ray system, Computer Tomography (CT) Imaging System, Magnetic Resonance Imaging System, Ultrasound Imaging System, Positron Emission Tomography (PET) Imaging System and Nuclear Medicine Imaging System.

19. The system as claimed in claim 13, wherein the image includes DICOM (Digital Imaging and Communications in Medicine) images and non-DICOM images.

20. The system as claimed in claim 13, wherein the processor is configured to incorporate patient information in a common language.
